(19) United States
(12) Patent Application Publication
(10) Pub. No.: US 2026/0246063 A1
(43) Pub. Date: Aug. 20, 2026

(54) SIMPLIFIED MOUNTING OF A BURSTING MEMBRANE BY REINFORCEMENT

(71) Applicant: Cellforce Group GmbH, Kirchentellinsfurt (DE)

(72) Inventors: Jürgen Gräf, Kirchentellinsfurt (DE); Manuel Will, Kirchentellinsfurt (DE)

(21) Appl. No.: 19/164,226

(22) PCT Filed: Mar. 14, 2024
(86) PCT No.: PCT/EP2024/056892

§ 371 Date: Sep. 11, 2025

(30) Foreign Application Priority Data
Mar. 14, 2023 (EP) 23161930.5

(51) Int. Cl. H01M 50/342

(52) U.S. Cl. CPC H01M 50/3425

(57) ABSTRACT

A membrane arrangement includes a bursting membrane and at least one reinforcing frame, wherein the reinforcing frame is connected to the bursting membrane, wherein the reinforcing frame connected to the bursting membrane is configured to be inserted into a cell housing on the inside and to be connected to the cell housing on the outside by a thermal joining process, and a related method includes connecting a bursting membrane to a battery cell housing and a battery cell with a membrane arrangement.

### BACKGROUND OF THE INVENTION

The invention relates to a membrane arrangement comprising a bursting membrane and comprising at least one reinforcing frame. Furthermore, the invention relates to a method for connecting a bursting membrane to a cell housing of a battery cell and to a battery cell with a membrane arrangement.

Electrochemical storage devices, such as lithium-ion batteries, can release gaseous components in certain situations and thus build up overpressure in the cell housing. Excessive pressure inside a battery cell housing or cell hosing can result in a risk of explosion. Battery cells with integrated predetermined breaking points are already known. For example, predetermined breaking points in the form of punched holes can be incorporated into the walls of battery cell housings in order to avoid a risky overpressure.

Furthermore, bursting membranes are already known which are connected to the outside of a battery cell housing cover. However, the problem with connecting bursting membranes on the outside, in particular by welding, is the need for a certain material thickness in order to enable a reliable connection of the bursting membrane to the corresponding section of the battery cell. For this reason, bursting membranes are predominantly arranged in a cell cover with a sufficient material thickness to avoid this problem. The cell cover usually forms the highest point of the battery cell and also has electrical connections. However, depending on the arrangement and orientation of the cell stacks, any gases that arise can only be dissipated inadequately or not completely via the cell cover. In addition, the electrical connections can impair the formation of a gas channel for removing gases from the battery cells. In particular, a bursting membrane incorporated in a cell cover can only be coupled gas-tightly to external channels with increased effort in order to enable controlled discharge of gaseous components from a battery system with a plurality of battery cells.

The present invention therefore has the object of creating a membrane arrangement and a method for connecting a bursting membrane which enable technically simple positioning of the bursting membrane in a bottom-side area of a cell housing, in particular an extruded or drawn cell housing.

### SUMMARY OF THE INVENTION

According to one aspect of the invention, a membrane arrangement is provided. The membrane arrangement has a bursting membrane and at least one reinforcing frame which is connected to the bursting membrane. According to the invention, the reinforcing frame connected to the bursting membrane is arranged to be inserted on the inside into a battery cell housing or cell housing and to be connected on the outside to the cell housing by a thermal joining process.

According to a further aspect of the invention, a battery cell is provided. The battery cell has a cell housing with at least one cell stack, which is arranged in an inner volume of the cell housing. Furthermore, the battery cell has at least one membrane arrangement according to the invention. Advantageously, the membrane arrangement is arranged in a bottom-side area of the cell housing.

This makes it possible to connect bursting membranes to particularly thin-walled battery cell housings in two steps. This measure also makes it possible to arrange the bursting membrane in any area of the cell housing, in particular in a bottom area of the battery cell. In a first step, the bursting membrane is connected to the reinforcing frame. This step can be carried out using a friction-fit and/or material-fit and/or form-fit connection. For example, the bursting membrane can be welded to the reinforcing frame. The resulting arrangement can then be inserted into an opening provided for this purpose or positioned at such an opening in the cell housing. The additional material thickness formed by the reinforcing frame can then be used to connect the bursting membrane to the cell housing in a second step.

The bursting membrane can be welded to a wall of the cell housing via the reinforcement frame. The additional material thickness of the reinforcing frame enables a process-reliable connection of any bursting membranes, which eliminates the need for separate production of bursting membranes as part of battery cell production.

By using the reinforcing frame, a joint, such as a weld seam, can be placed in an area of the cell housing that does not fulfil any other function. This means, for example, that sealing surfaces or outer surfaces of the cell housing for accommodating seals can be kept free of joints or weld seams in order to achieve a particularly optimal sealing effect.

In another embodiment, the bursting membrane is plate-shaped. Advantageously, the bursting membrane rests on the edge of the reinforcing frame or is inserted into a recess in the reinforcing frame and connected to the reinforcing frame. This measure allows the bursting membrane to be connected to the reinforcing frame in a particularly versatile manner.

Joining methods such as laser welding, ultrasonic welding, soldering and the like can be used to join the bursting membrane to the reinforcing frame. Advantageously, at least one first joint connection can be introduced which connects the bursting membrane to the reinforcing frame with a material bond. Such a first joint connection can, for example, take the form of a circumferential weld seam.

The membrane arrangement can then be connected to a section or a wall of a cell housing using at least one second joint connection.

In this case, the first joint connection can be offset at least in some areas from the second joint connection. As a result, the opening of the cell housing and the bursting membrane can have different sizes, which increases the selection of usable bursting membranes.

The bursting membrane can be optimally supported mechanically if the reinforcing frame is designed as a circumferential reinforcing frame. Advantageously, the reinforcing frame is bonded to the bursting membrane along its entire circumference. This ensures a fluid-tight connection between the bursting membrane and the reinforcing frame.

According to a further embodiment, the reinforcing frame has at least one positioning pin. The reinforcing frame connected to the bursting membrane can be aligned with an opening of the cell housing by means of the at least one positioning pin. Advantageously, the at least one positioning pin protrudes at least partially into the opening of the cell housing. The use of the positioning pin enables easier assembly of the membrane arrangement and precise alignment of the membrane arrangement with respect to the opening of the cell housing.

The alignment of the membrane arrangement can be particularly precise if the positioning pin is designed as a circumferential positioning pin. The circumferential positioning pin is also shaped in such a way that it is inserted into the opening and runs parallel to an edge contour of the opening of the cell housing. This measure allows the at least one second joint connection to run along the contour of the opening of the cell housing, thus connecting the contour of the opening to the positioning pin with a material bond. This allows the reinforcing frame to be connected to the cell housing in a particularly process-reliable manner. The parallel course of the positioning pin to the contour of the opening enables particularly optimal tool access for inserting the second joint connection.

The membrane arrangement can be additionally stiffened or reinforced structurally if at least one reinforcing cage is arranged on the reinforcing frame.

According to a further embodiment, the at least one reinforcing cage is arranged on the inside of the cell housing or on the outside of the cell housing on the reinforcing frame. The arrangement of the reinforcing cage on an inner side of the cell housing can efficiently prevent blocking of an area in front of the bursting membrane, so that the protective mechanism of the bursting membrane can always be ensured. An arrangement of the reinforcement cage on an outer side of the cell housing can be used analogously to keep an area outside the cell housing free in order to enable reliable escape of gaseous components of the battery cell in the event of overpressure via the bursting membrane.

The at least one reinforcing cage can be connected to the reinforcing frame particularly efficiently if the reinforcing frame connected to the bursting membrane is set up to be connected to the outside of the cell housing directly or indirectly via the at least one reinforcing cage using a thermal joining process. This allows a joint connection, such as a weld seam, to be made through areas of the reinforcing cage, which simultaneously connects the reinforcing frame to the cell housing.

According to a further embodiment example, the reinforcing frame has at least one edge-side bevel and/or a stall edge. An edge-side bevel can enable particularly optimal aerodynamics of a flow that flows out through an activated or broken bursting membrane. The use of a stall edge can be used to convert the flow from the battery cell resulting from an overpressure from a laminar flow state to a turbulent flow state, whereby the flow velocity can be increased and the overpressure can be reduced more quickly.

According to a further aspect of the invention, a method for connecting a bursting membrane to a battery cell housing is provided. In one step, the bursting membrane is aligned relative to a reinforcing frame and connected to the reinforcing frame with a material bond. In a further step, the reinforcing frame connected to the bursting membrane is positioned on the inside in an internal volume of a cell housing at an opening in the cell housing. The reinforcing frame is then joined to the cell housing by applying a thermal joining process to an outer side of the cell housing in the area of the opening.

The method according to the invention can ensure optimum tool access to the corresponding joint connections during the application of the joining method. In particular, the method avoids the introduction of a weld seam from the inside of the cell housing with the resulting need for particularly small or narrow tools. The method makes it possible to join the respective components by introducing joint connections on external surfaces, such as an outwardly directed contour of the opening of the cell housing.

According to one embodiment, the reinforcing frame is joined to the cell housing by a thermal joining process in the form of laser welding, soldering, contact welding or thermally activated bonding. As a result, the introduction of first joint connections and/or second joint connections can be realized flexibly with the aid of different tools or joining processes.

The membrane arrangement can be inserted into the cell housing with particular technical ease if the reinforcing frame connected to the bursting membrane is positioned on the inside in an internal volume of the cell housing with the aid of at least one positioning pin at an opening in the cell housing. In particular, the membrane arrangement can be inserted into the opening of the cell housing and optionally latched with the opening if the positioning pin is arranged adjacent to an edge contour of the opening of the cell housing. In this way, subsequent slippage of the membrane arrangement can be avoided if it is connected to the cell housing with a material bond.

According to a further embodiment example, the reinforcing frame is connected to the cell housing by inserting at least one weld seam in an area between the at least one positioning pin and the edge contour of the opening of the cell housing. This measure allows the area between the edge contour of the opening and the positioning pin to be reliably connected by inserting a weld seam. With such a connection, the requirements for the accuracy of the tool guidance are relatively low, so that such a connection is particularly quick and technically simple to implement.

### BRIEF DESCRIPTION OF THE DRAWINGS

Several embodiment examples of the invention are explained in more detail below with reference to the drawings. They show

FIG. 1 is a schematic sectional view of a membrane arrangement according to one embodiment of the invention;

FIG. 2 is a schematic sectional view of a bottom-side area of a cell housing of a battery cell with an inserted membrane arrangement from FIG. 1;

FIG. 3 is a schematic sectional view of a bottom-side area of a cell housing with a membrane arrangement according to a second embodiment of the invention;

FIG. 4 is a schematic sectional view of a bottom-side area of a cell housing with a membrane arrangement according to a third embodiment of the invention;

FIG. 5 is a schematic sectional view of a bottom-side area of a cell housing with a membrane arrangement according to a fourth embodiment of the invention;

FIG. 6 is a schematic sectional view of a bottom-side area of a cell housing with a membrane arrangement according to a fifth embodiment of the invention; and

FIG. 7 is a schematic sectional view of a bottom-side area of a cell housing with a membrane arrangement according to a sixth embodiment of the invention.

### DETAILED DESCRIPTION OF THE PREFERRED EMBODIMENTS

In the figures, identical reference numerals indicate the same elements or structural components. The sizes and relative positions of the elements in the figures are not necessarily drawn to scale, and some of these elements are shown enlarged and positioned for clarity. In addition, the particular shapes of the elements drawn are not intended to convey any information about the actual shape of the individual elements, but have been selected solely for ease of recognition in the figures.

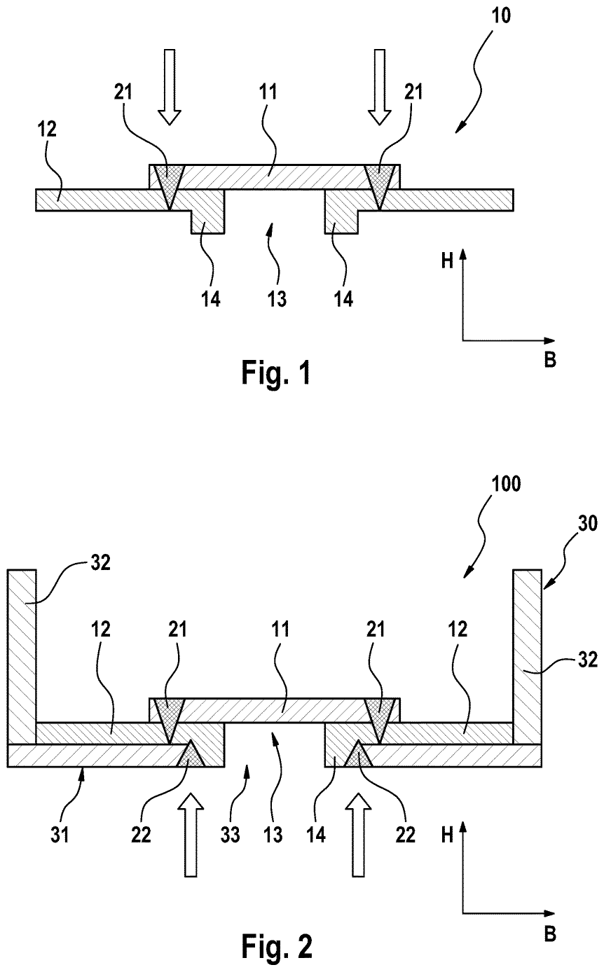

FIG. 1 shows a schematic sectional view of a membrane arrangement 10 according to one embodiment of the invention. In the embodiment example shown, the membrane arrangement 10 has a bursting membrane 11 and a reinforcing frame 12. The sectional view serves to illustrate an extension of the membrane arrangement 10 along a width direction B and a height direction H.

The reinforcing frame 12 is connected to the bursting membrane 11 with a material bond. For this purpose, a first joint connection 21 was introduced through the bursting membrane 11, which creates a materially bonded joint connection between the reinforcing frame 12 and the bursting membrane 11. The arrows illustrate a direction of action by a tool not shown, such as a laser welding tool. The first joint connection 21 can, for example, be designed as a circumferential weld seam.

The reinforcing frame 12 is designed as a circumferential frame and has a centrally arranged recess 13, so that the bursting membrane 11 can break or fold open into the recess 13 in the event of overstressing due to overpressure.

The reinforcing frame 12 connected to the bursting membrane 11 is designed to be inserted into a battery cell housing or cell housing 30 on the inside and connected to the cell housing 30 on the outside by a thermal joining process (see FIG. 2).

The reinforcing frame 12 has a positioning pin 14 as an example. The reinforcing frame 12 connected to the bursting membrane 11 can be aligned with an opening 33 of the cell housing 30 shown in FIG. 2 by means of the positioning pin 14. The positioning pin 14 protrudes into the opening 33 of the cell housing 30.

The positioning pin 14 is circumferentially or annularly shaped and surrounds the recess 13 of the reinforcing frame 12 on the circumferential side. The positioning pin 14 is shaped such that, when inserted into the opening 33 of the cell housing 30, it runs parallel to an edge-side contour of the opening 33 of the cell housing 30 or runs along this contour of the opening 33.

FIG. 2 shows a schematic sectional view of a bottom-side area 31 or bottom of a cell housing 30 of a battery cell 100 with an inserted membrane arrangement 10 from FIG. 1. For the sake of clarity, the other components of the battery cell 100, such as cell stacks, cell connectors, battery terminals, electrolyte and the like are not shown.

The membrane arrangement 10 is arranged in the bottom-side area 31 in such a way that the positioning pin 14, which is shaped as a positioning ring, projects positively into the opening 33. Preferably, the entire reinforcing frame 12 lies flat and flush on an inner side of the bottom-side area 31.

The opening 33 can have a round, oval, rectangular or similar cross-section. The membrane arrangement 10 reinforces the bottom-side area 31 of the cell housing 30. The membrane arrangement 10 is connected to the bottom-side area 31 of the cell housing 30 by a circumferential second joint connection 22. The second joint connection 22 is exemplarily designed as a weld seam.

The arrows in FIG. 2 illustrate the effect of a joining tool, such as a laser welding tool, from an outside on a circumferential gap between the positioning pin 14 and the contour of the opening 33 of the cell housing 30.

In the illustrated embodiment example, the reinforcing frame 12 protrudes as far as the lateral walls 32 of the cell housing 30 and thus stiffens the cell housing 30 on the bottom side.

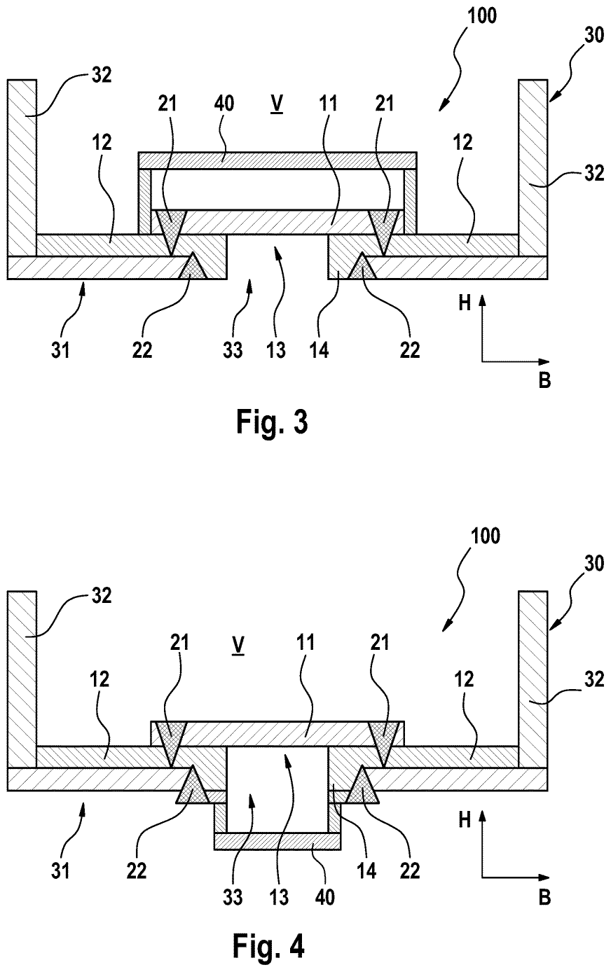

FIG. 3 illustrates in a schematic sectional view a bottom-side area 31 of a cell housing 30 with a membrane arrangement 10 according to a second embodiment of the invention. In contrast to the embodiment example shown in FIG. 2, the membrane arrangement 10 here has an additional structural stiffening in the form of a reinforcing cage 40.

The reinforcing cage 40 surrounds the bursting membrane 11 on the outside and enables a free inflow to the bursting membrane 11 in the inner volume V of the cell housing 30.

In an alternative or additional embodiment, which is illustrated in FIG. 4, the membrane arrangement 10 has a reinforcing cage 40, which is connected to the outside of the reinforcing frame 12. Thus, an area outside the inner volume V of the cell housing 30 is kept free by the reinforcement cage 40.

Furthermore, the reinforcement cage 40 enables additional reinforcement of the bursting membrane 11 and the reinforcement frame 12.

In FIG. 4, the reinforcing frame 12 connected to the bursting membrane 11 is also connected to the outside of the cell housing 30 directly via the reinforcing cage 40. In this way, a second joint connection 22, such as a weld seam, can be introduced through areas or sections of the reinforcing cage 40, which at the same time also connects the reinforcing frame 40 to the cell housing 30 in addition to the reinforcing frame 12.

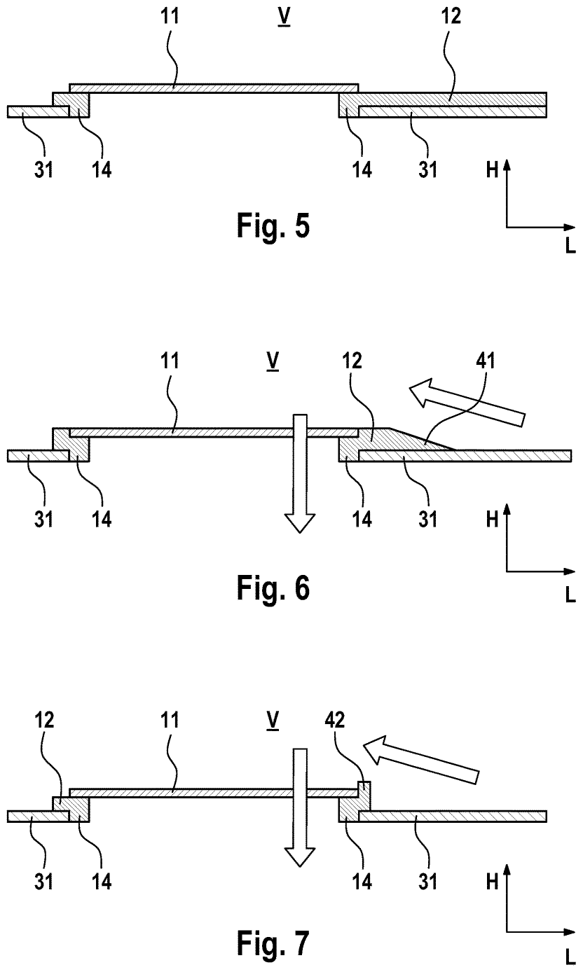

FIG. 5 shows a schematic sectional view of a bottom-side area 31 of a cell housing 30 with a membrane arrangement 10 according to a fourth embodiment of the invention. In contrast to the figures already described, a sectional view is shown here to illustrate an extension of the membrane arrangement 10 along a longitudinal direction L.

To enable particularly efficient reinforcement or stiffening of the bottom-side area 31, the reinforcing frame 12 projects beyond the opening 33 on one side and extends essentially over the entire bottom-side area 31 of the cell housing 30 along the extension of the cell housing 30 in the longitudinal direction L.

For the sake of clarity, no joint connections 21, 22 are shown in FIG. 5, FIG. 6 and FIG. 7.

In FIG. 6, a schematic sectional view of a bottom-side area 31 of a cell housing 30 with a membrane arrangement 10 according to a fifth embodiment of the invention is illustrated. In this embodiment, the reinforcing frame 12 has at least one edge-side bevel 41.

Such an edge-side slope 41 can improve the aerodynamics of a flow which flows out through a bursting membrane 11 actuated or broken by means of overpressure. The flow can have gaseous and liquid components of the electrolyte and is illustrated by the arrows.

According to a sixth embodiment, which is shown in FIG. 7, a further membrane arrangement 10 with a reinforcing frame 12 is illustrated. The reinforcing frame 12 has a stall edge 42.

The stall edge 42 is essentially perpendicular to the bottom-side area 31 and thus protrudes into the inner volume V of the cell housing 30. Depending on the configuration, a stall edge 42 can be arranged at the edge of the reinforcing frame 12 in the longitudinal direction L in order to force a stall with a resulting turbulent flow when a flow is generated.

Analogous to FIG. 6, the flow results from an actuation or rupture of the bursting membrane 11 by exceeding a predefined pressure in the inner volume V of the cell housing 30. The flow thus consists of components that escape from the cell housing 30 and is illustrated by the arrows.

1.-14. (canceled)

15. A membrane arrangement, comprising:
a bursting membrane; and
at least one reinforcing frame;
wherein the reinforcing frame is connected to the bursting membrane; and
wherein the reinforcing frame connected to the bursting membrane is configured to be inserted on an inside into a cell housing and to be connected on an outside to the cell housing of a battery cell by a thermal joining process.

16. The membrane arrangement according to claim 15, wherein the bursting membrane is in the form of a plate, wherein the bursting membrane rests on an edge of the reinforcing frame or is placed in a recess of the reinforcing frame and is connected to the reinforcing frame.

17. The membrane arrangement according to claim 16, wherein the reinforcing frame is configured as a circumferential reinforcing frame, wherein the reinforcing frame is connected to the bursting membrane in a material-locking manner along an entire circumference.

18. The membrane arrangement according to claim 17, wherein the reinforcing frame has at least one positioning pin, wherein the reinforcing frame connected to the bursting membrane is configured to be aligned with an opening of the cell housing via the at least one positioning pin, wherein the at least one positioning pin projects at least partially into the opening of the cell housing.

19. The membrane arrangement according to claim 18, wherein the positioning pin is configured as a circumferential positioning pin, wherein the circumferential positioning pin is shaped such that the circumferential pivoting pin extends parallel to an edge-side contour of the opening of the cell housing when inserted into the opening.

20. The membrane arrangement according to claim 19, wherein at least one reinforcing cage is arranged on the reinforcing frame.

21. The membrane arrangement according to claim 20, wherein the at least one reinforcing cage is arranged on the inside of the cell housing or on the outside of the cell housing on the reinforcing frame.

22. The membrane arrangement according to claim 21, wherein the reinforcing frame connected to the bursting membrane is configured to be connected on the outside directly or indirectly via the at least one reinforcing cage to the cell housing by a thermal joining process.

23. The membrane arrangement according to claim 15, wherein the reinforcing frame has at least one edge-side bevel and/or a stall edge.

24. The membrane arrangement according to claim 15, wherein the reinforcing frame is configured as a circumferential reinforcing frame, wherein the reinforcing frame is connected to the bursting membrane in a material-locking manner along an entire circumference.

25. The membrane arrangement according to claim 15, wherein the reinforcing frame has at least one positioning pin, wherein the reinforcing frame connected to the bursting membrane is configured to be aligned with an opening of the cell housing via the at least one positioning pin, wherein the at least one positioning pin projects at least partially into the opening of the cell housing.

26. The membrane arrangement according to claim 25, wherein the positioning pin is configured as a circumferential positioning pin, wherein the circumferential positioning pin is shaped such that the circumferential pivoting pin extends parallel to an edge-side contour of the opening of the cell housing when inserted into the opening.

27. The membrane arrangement according to claim 15, wherein at least one reinforcing cage is arranged on the reinforcing frame.

28. The membrane arrangement according to claim 27, wherein the at least one reinforcing cage is arranged on the inside of the cell housing or on the outside of the cell housing on the reinforcing frame.

29. The membrane arrangement according to claim 28, wherein the reinforcing frame connected to the bursting membrane is configured to be connected on the outside directly or indirectly via the at least one reinforcing cage to the cell housing by a thermal joining process.

30. A method for connecting a bursting membrane to a cell housing of a battery cell, comprising:
aligning the bursting membrane relative to a reinforcing frame;
connecting the bursting membrane to the reinforcing frame in a material-locking manner;
positioning the reinforcing frame connected to the bursting membrane on an inside in an inner volume of the cell housing at an opening of the cell housing; and
joining the reinforcing frame in a material-locking manner to the cell housing by applying a thermal joining process on an outer side of the cell housing in the area of the opening.

31. The Method according to claim 30, wherein the reinforcing frame is joined to the cell housing in a material-locking manner by a thermal joining method configured as laser welding or as soldering or as contact welding or as thermally activatable bonding.

32. The method according to claim 30, wherein the reinforcing frame connected to the bursting membrane is positioned on the inside in an inner volume of the cell housing with the aid of at least one positioning pin at an opening of the cell housing, and wherein the positioning pin is arranged adjacent to an edge contour of the opening of the cell housing.

33. The method according to claim 32, wherein the reinforcing frame is connected to the cell housing by introducing at least one weld seam in an area between the at least one positioning pin and the edge contour of the opening of the cell housing.

34. A battery cell, comprising:
a cell housing with at least one cell stack arranged in an inner volume of the cell housing; and
a membrane arrangement according to claim 15, wherein the membrane arrangement is arranged in a bottom-side area of the cell housing.
